(19) United States
(12) Patent Application Publication
(10) Pub. No.: US 2009/0101216 A1
(43) Pub. Date: Apr. 23, 2009

(54) Scavenging Valve for a Hydraulic Circuit

(76) Inventor: Steven Donders, Haigerloch (DE)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/920,796

(22) PCT Filed: Aug. 4, 2006
(86) PCT No.: PCT/EP2006/007743

§ 371 Date: Nov. 20, 2007

(30) Foreign Application Priority Data
Aug. 4, 2005 (DE) 10 2005 036 854.9
Oct. 26, 2005 (DE) 10 2005 051 324.7

(51) Int. Cl. F16K 21/04

(52) U.S. Cl. 137/511

(57) ABSTRACT

The invention relates to a scavenging valve for a closed hydraulic circuit. A valve piston (40) is arranged in a longitudinally displaceable manner in a clearance (36) in a valve housing (35). Said scavenging valve (21) has at least three pressure spaces (41, 42, 43) which are constructed in an axially consecutive manner. Two of said pressure spaces (41, 42, 43) can be connected to one another other at a time in dependence upon a relative position of the valve piston (40) in relation to the valve housing (35). In order to interrupt the connection between the pressure spaces (41, 42, 43), a sealing element (44, 45), which effects sealing against a valve-seat face (50) constructed in the housing, is provided in each case.

The invention relates to a scavenging valve for a closed hydraulic circuit.

In a closed hydraulic circuit belonging, for example, to a hydraulic drive, a pressure medium is delivered by a hydrostatic pump. The pressure medium delivered flows to a hydraulic motor, which it drives, before flowing back to the suction side of the hydraulic pump. In the course of operation of a hydrostatic drive of this kind, the pressure medium undergoes considerable heating-up. Since closed hydraulic circuits of this kind are, as a rule, designed for delivery in both directions, cooling of the pressure medium located in the closed circuit is possible only with difficulty. In order to prevent a critical increase in the temperature of the pressure medium, therefore, there is extracted from the closed circuit, in a controlled manner, a quantity of pressure medium which is replaced by a cooled and filtered pressure medium. So as not to reduce the efficiency of the hydraulic drive, it is customary to extract the pressure medium from the working line which is conducting the low pressure at the time. The cooled pressure medium is fed in via a feed device by which the volume which has been extracted is replaced in the working line on the low-pressure side.

For the purpose of extracting the pressure medium, scavenging devices are known which are connected to the two working lines arranged between the pump and the motor. Under these circumstances, the working line which is conducting the low pressure at the time is connected to a pressure-limiting valve by a scavenging valve. A scavenging valve of this kind is known from DE 31 06 610 A1. In the scavenging valve indicated in the latter, a valve piston is arranged in a longitudinally displaceable manner in a valve housing. Said valve piston is centred by two compression springs arranged on opposite faces of the valve piston. A pressure space is arranged, in each case, on either side of the valve piston. Each of the two pressure spaces is connected to one of the two working lines. Constructed between these two pressure spaces is an additional space which is sealed in relation to both pressure spaces when the valve is in the inoperative position. For sealing purposes, a fit is constructed between sealing sections on the ends of the valve piston and a corresponding bore in the valve housing. When pressurisation occurs in one of the two pressure spaces, the valve piston is displaced in the direction of the opposite pressure space. In the process, the sealing section of the valve piston, which is displaced in this way in the direction of the pressure space having lower pressure, leaves that region of the valve housing which is constructed as a fit. By this means, a connection through which flow can take place is opened between the pressure space having the lower pressure and the additional pressure space. This additional pressure space is connected to a tank volume via a return line.

What is disadvantageous about the scavenging valve which is known from DE 31 06 610 A1 is the fact that sealing between the valve piston and the valve housing takes place via an annular gap. As a result of the repeated axial movement of the valve piston, wear which impairs the sealing action of the annular gap occurs in the bore constructed in the housing. The leakage volume, which sets in along the annular gap in the direction of the tank volume, thus increases in the course of operation. Since scavenging valves are, as a rule, integrated directly into a housing section of hydraulic pumps or motors which consist, for example, of grey or spheroidal cast iron, reconditioning in the event of wear is particularly difficult.

The underlying object of the invention is to provide a scavenging valve which is improved from the point of view of wear during operation and can be overhauled in a simple manner in the case of an impaired sealing action.

This object is achieved by means of the scavenging valve having the features in claim 1.

The scavenging valve according to the invention in accordance with claim 1 has a valve piston which is arranged in a longitudinally displaceable manner in a clearance in a valve housing. At least three axially consecutive sections are constructed on the valve. Each of the three consecutive sections has a pressure space, it being possible to connect two of said pressure spaces to one another at a time, depending upon the relative position of the valve piston. In order to be able to interrupt the connection between the individual pressure spaces, a valve-seat face, which cooperates with a sealing element in a sealing manner, is constructed in the housing. In this way a seat valve is produced, in each case, between the pressure spaces which are to be connected to one another in order to extract pressure medium, as a result of which considerably reduced wear occurs when the scavenging valve is in operation. Furthermore, it is possible to change the sealing elements of the scavenging valve in a simple manner in the event of wear. It is thus possible, in a simple manner, to repair a valve which is inserted in the housing of a pump or a motor.

Advantageous further developments of the scavenging valve according to the invention are represented in the subclaims.

It is advantageous, in particular, for the sealing element to be constructed as a bush which is penetrated by the valve piston. A sealing action between the valve piston and the sealing element constructed as a bush is achieved by means of a corresponding sealing section on said valve piston. Under these circumstances, it is particularly advantageous to select the radial extent of said sealing section on the valve piston to be as small as possible, in particular smaller than the radial extent between the sections of the valve piston which are constructed as guide sections.

It is also advantageous to provide a clearance on the sealing element constructed as a bush, on its end face which is oriented towards the valve-seat face, so that an annular sealing face is constructed around the said clearance. Under these circumstances, the diameter of the clearance may be determined in such a way that the desired pressure per unit of area is established at the annular sealing face. In particular, it is advantageous to centre the valve piston via two centring springs which act on said valve piston via a sealing element in each case. The valve piston is therefore acted upon by means of an axial force by the centring springs until said two centring springs hold the sealing elements in sealing contact against the valve-seat faces. At the same time, said centring springs provide the necessary closing force on the bushes, and the pressure per unit of area on the valve-seat faces.

A preferred exemplified embodiment of the scavenging valve according to the invention is represented in the drawings and will be explained in greater detail in the description that follows. In said drawings:

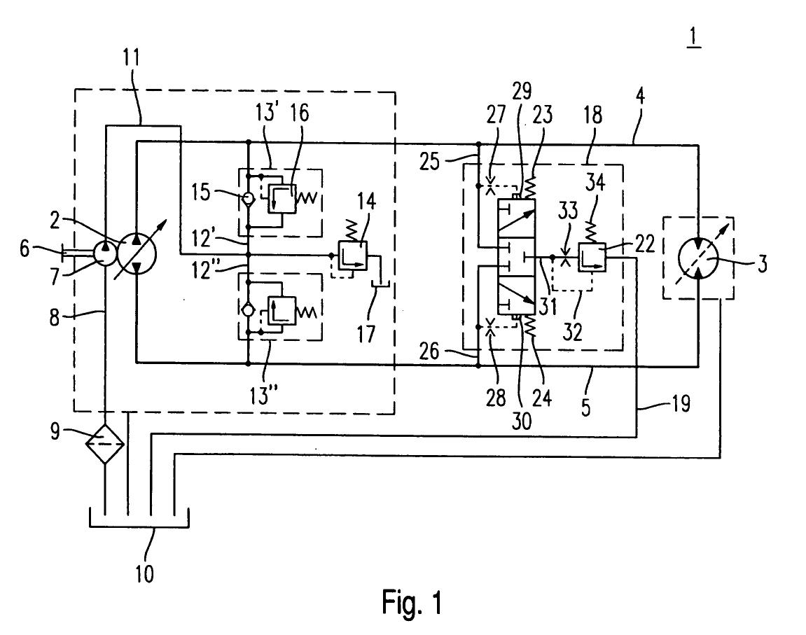

FIG. 1 shows a hydraulic circuit diagram of a closed hydraulic circuit with a scavenging valve unit;

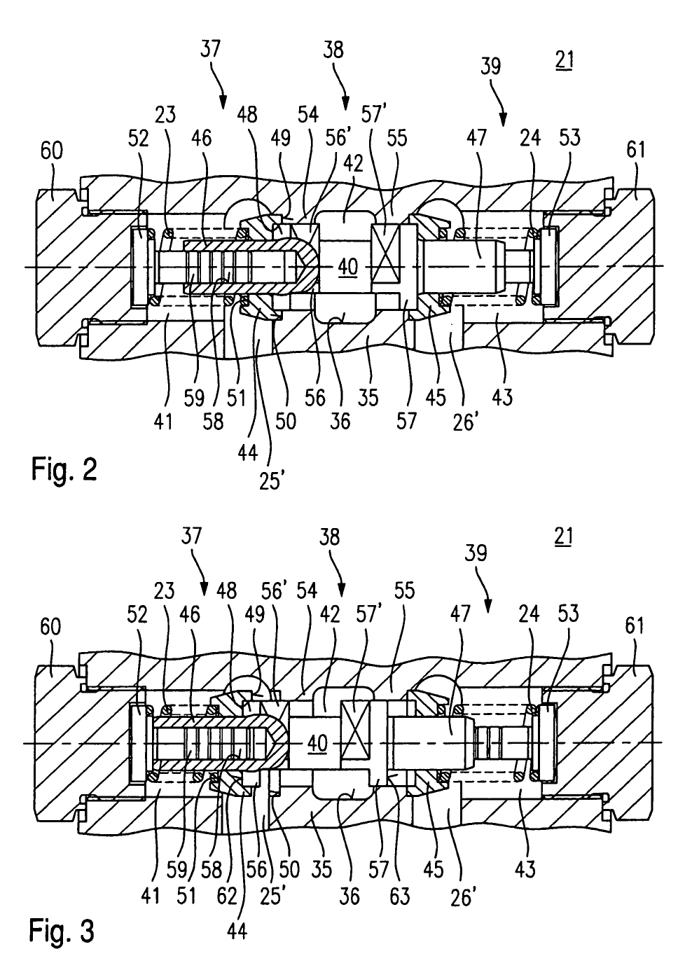

FIG. 2 shows an exemplified embodiment of a scavenging valve according to the invention, in its inoperative position; and

FIG. 3 shows the scavenging valve according to the invention, in a deflected position.

Before the scavenging valve according to the invention is gone into in greater detail, a closed hydraulic circuit will first of all be explained with the aid of the circuit diagram in FIG. 1 for the sake of better understanding. FIG. 1 shows a closed hydraulic circuit 1, in which an adjustable hydraulic pump 2 delivers a pressure medium. A hydraulic motor 3, which is preferably likewise adjustable, is connected to said hydraulic pump 2 via a first working line 4 and a second working line 5 in a closed circuit. In the exemplified embodiment represented, both the hydraulic pump 2 and the hydraulic motor 3 are of reversible design. A driving motor, which is not represented but which is connected to the hydraulic pump 2 via a drive shaft 6, serves to drive said hydraulic pump 2.

Together with the hydraulic pump 2, a feed pump 7 is connected to the drive shaft 6. Said feed pump 7 is intended for delivery in only one direction and is preferably constructed as a fixed displacement pump. The feed pump 7 serves to fill the hydraulic circuit.

In order to fill the hydraulic circuit, the feed pump 7 sucks pressure medium out of a tank volume 10 via a suction line 8 and a filter 9 which is provided in the latter. Said feed pump 7 delivers the pressure medium sucked in into the first working line 4 via a feed line 11 and via a first connecting line 12′, and into the second working line 5 via a second connecting line 12″. A first feed valve 13′ is arranged in the first connecting line 12′. In the same way, a second feed valve 13″ is arranged in the second connecting line 12″. The functioning of the two feed valves 13′ and 13″ is identical, so that the setup will be explained below merely with the aid of the feed valve 13′.

In order to prevent an excessively high feed pressure, the feed line 11 is protected via a feed-pressure-limiting valve 14. If the pressure in the feed line 11 exceeds a predetermined value, the spring-loaded feed-pressure-limiting valve 14 opens and unblocks a connection, through which flow can take place, from the feed line 11 into an internal tank volume 17 in the hydraulic pump unit.

The first feed valve 13′ has a non-return valve 15 which opens in the direction of the first working line 4. A spring-loaded pressure-limiting valve 16 is arranged parallel to said non-return valve 15. As long as the pressure prevailing in the first working line 4 is lower than the pressure fed into the first connecting line 12′ via the feed line 11, the non-return valve 15 opens and said first working line 4 is filled with pressure medium by the feed pump 7. If, on the other hand, the pressure in the first working line 4 exceeds the feed-line pressure in the course of operation, the non-return valve 15 closes. In the event of a further rise in pressure which could lead to critical loading of the system, the pressure-limiting valve 16 opens, so that the first working line 4 is relieved of pressure towards the feed line 11 via said pressure-limiting valve 16. Since said feed line 11 is protected via the feed-pressure-limiting valve 14, the pressure of the first working line 4 is released into the tank volume 17 in such a case.

The second feed valve 13″, which is provided for the purpose of filling and protecting the second working line 5, corresponds to the first feed valve 13′ in its make-up, so a repeated description will be dispensed with.

In order to cool the pressure medium which is being delivered in the hydraulic circuit, pressure medium is extracted from said closed hydraulic circuit and cooled pressure medium from the tank volume 10 replaces, via the feed device already described, the quantity which has been extracted. Cooling may take place, for example, by means of a suitably designed filter 9 or of additional coolers which are not represented in the drawings.

A scavenging device 18 is provided for extracting the scavenging oil. Said scavenging device 18 is connected, via a first extracting line 25 and a second extracting line 26, to the first working line 4 and second working line 5 respectively. The scavenging oil extracted via the first extracting line 25 or the second extracting line 26, respectively, is discharged into the tank volume 10 via a return line 19. A scavenging valve 21, which is designed as a 3/3-way valve in the exemplified embodiment represented, is provided for extracting pressure medium from the particular low-pressure side. That working line 4 or 5 in which, depending upon the direction of delivery of the hydraulic pump 2, the lower pressure prevails, is connected, in each case, to an output connection 31 via the scavenging valve 21. The output connection 31 of the scavenging valve 21 is connected to an input of a pressure-limiting valve 22. Said pressure-limiting valve 22 opens at a set pressure and thus connects the output connection 31 of the scavenging valve 21 to the tank volume 10 via the return line 19.

The scavenging valve 21 is held in its inoperative position, which is represented in FIG. 1, by a first centring spring 23 and a second centring spring 24. In the inoperative position represented, all the connections of the scavenging valve 21 are separated from one another. If, for example, the pressure in the first working line 4 exceeds the pressure prevailing in the second working line 5, the working-line pressure in the first working line 4 acts upon a first measuring face 29 via the first extracting line 25 and via a restrictor 27. An axial force on the scavenging valve 21, which force acts against the second centring spring 24, is generated by the pressure which is present at the first measuring face 29. As a result, the scavenging valve 21 is deflected in the direction of a first end position. In the said first end position, the second extracting line 26 is connected to the output connection 31.

Conversely, if the pressure prevailing in the second working line 5 exceeds the pressure prevailing in the first working line 4, the working-line pressure in the second working line 5 is fed to a second measuring face 30 via the second extracting line 26 and a second restrictor 28. The hydraulic force which is operating there displaces a valve piston of the scavenging valve 21, starting from the inoperative position of said piston, against the force of the first centring spring 23. Said scavenging valve 21 is thus deflected in the direction of its second end position, in which the first working line 4 is connected to the output connection 31 via the first extracting line 25.

That working line 4, 5 in which the lower pressure prevails is thus connected, in each case, to the output connection 31 by the scavenging valve 21 in dependence upon the pressure conditions in the first working line 4 and in the second working line 5. The pressure-limiting valve 22 serves to set a minimum pressure in the first or second working line 4 or 5 which is conducting the low pressure at the time. For this purpose, the output connection 31 is connected to an input of the pressure-limiting valve 22 via an additional restrictor 33. A hydraulic force, which is generated by the pressure prevailing upstream of the additional restrictor 33, acts on the pressure-limiting valve 22 against the force of a setting spring 34. If the said pressure which is prevailing upstream of the restrictor 33 and is fed in via a by-pass line 32 exceeds a value which can be fixed via the setting spring 34, the pressure-limiting valve 22 opens and unblocks the flow path to the return line 19 and thereby to the tank volume 10. Whereas that working line 4 or 5 which has the lower pressure is always connected to the output connection 31 via the scavenging valve 21, a minimum pressure for the working line 4 or 5 which is conducting the low pressure is fixed by the additional pressure-limiting valve 22.

Represented in FIG. 2 is a partial section through a scavenging valve 21 according to the invention. Said scavenging valve 21 is arranged in a valve housing 35 which is penetrated by a clearance 36. A first section 37, a second section 38 and a third section 39 are arranged along the longitudinal extent of the clearance 36. Constructed in the consecutive sections 37 to 39 are a first pressure space 41, a second pressure space 42 and a third pressure space 43. Said pressure spaces 41-43 are formed by an enlargement in the radial extent of the clearance 36, so that a volume is produced, in each case, around a valve piston 40 which is arranged in the clearance 36. Alternatively, the pressure spaces 41-43 may also be produced by a corresponding reduction in a diameter of said valve piston 40.

In FIG. 2, the valve piston 40 is represented in its centred position, in which the scavenging valve 21 is located in the central position represented in FIG. 1. In this central position, no connection through which flow can take place exists between the pressure spaces 41 and 42 or 42 and 43. In order to seal the first pressure space 41 in relation to the second pressure space 42, a sealing element is provided which is constructed as a bush 44 in the exemplified embodiment represented. In the same way, there is provided, for the purpose of sealing the third pressure space 43 in relation to the second pressure space 42, a second bush 45 whose structural shape corresponds to the first bush 44. In order to avoid unnecessary repetitions, therefore, only the geometrical embossing of the first bush 44 will be explained below.

The first bush 44 has a central through-aperture by means of which said first bush 44 is pushed over a cylindrical first end 46 of the valve piston 40. Said first end 46 cooperates, as a sealing section, with the clearance in the first bush 44 in a sealing manner. A first clearance 48 is located in the end face of the first bush 44 on its side that faces towards the second pressure space 42. Because of said first clearance 48, an annular section of the first bush 44 is left, whose end face constructs a sealing face 49. The said annular sealing face 49 cooperates in a sealing manner with a valve-seat face 50 which is constructed in the housing 35. In order to keep the sealing face 49 in sealing contact with the valve-seat face 50, the first bush 44 is acted upon in the axial direction by the force of the first centring spring 23. In order to receive the spring, a second clearance 51 is provided on that end of the first bush 44 which faces away from the second pressure space 42. At the opposite end of the first centring spring 23, said spring is supported on an abutment 52.

In the exemplified embodiment represented, the first pressure space 41 is connected to the first working line 4, for example via a conduit 25′ which is designed as a bore and which constructs the first extracting line 25. In corresponding manner, the third pressure space 43 is connected to the second working line 5 via a conduit 26′ which is, once again, designed as a bore and which corresponds to the second extracting line 26. In the first pressure space 41 or the third pressure space 43, the pressure prevailing at the time in the first working line 4 or the second working line 5 respectively, thus acts upon the end face of the valve piston 40. There is thus generated on the valve piston 40, at the opposite end faces of said valve piston 40 in each case, an axial force which acts against the force of the second centring spring 24 or the first centring spring 23, which springs are arranged in the third and first pressure spaces 43 and 41, respectively.

In the casing 35, a guide 54, 55 is constructed, in each case, between the first section 37 and the second section 38, and between the second section 38 and the third section 39 of the scavenging valve 21. Said guides 54, 55 cooperate with a corresponding guide section 56, 57, in each case, on the valve piston 40. In order to permit a connection, through which flow can take place, between the first pressure space 41 and the second pressure space 42 in the event of an axial displacement of the valve piston 40, or between the third pressure space 43 and the second pressure space 42 in the event of a reverse deflection, flattened points are provided, in each case, in the region of the two guide sections 56, 57. A number of such flattened points 56′ and 57′ are preferably provided, arranged in a manner distributed over the periphery of the guide sections 56 and 57. Said flattened points are preferably confined to an axial partial region of said guide sections 56 and 57.

In order to permit sealing between the first pressure space 41 and the second pressure space 42, a fit is constructed between the first end 46 of the valve piston 40 and the central clearance in the first bush 44. As opposed to a fit, which has hitherto been customary, in the region of the guide sections 56, 57 on the valve piston 40, this has the advantage that the radial extent of the first or second end, 46, 47 respectively, of the valve piston 40 is reduced, compared to the guide sections 56, 57. The leakage of pressure medium occurring along a fit depends upon the cross-section of the gap occurring as a result of the fit. Under these circumstances, the arrangement of the fit in the region of the first end 46 or second end 47 of the valve piston 40 results not only in the advantage that an annular gap, which occurs in the region of the fit, between the first or second bush 44 or 45 and the first or second end 46, 47 respectively, of the valve piston 40, has a smaller cross-sectional area, overall, because of the smaller external diameter, but in addition it is also possible to manufacture a fit having a smaller diameter with greater precision.

A hardened outer face may, for example, be constructed on the valve piston 40 in the region of its first end 46 in order to reduce wear. It is equally possible to harden the first bush 44 in order to reduce wear, and thereby reduce the increase in leakage over the duration of operation. Furthermore, the valve-seat face on the side of the valve housing 35 may be formed by a pressed-in valve-seat ring which may likewise be hardened.

The first end 46 of the valve piston 40 is provided with a blind bore 58. A peg-shaped extension 59 on the first abutment 52 engages in said blind bore 58. Said first abutment 52 is approximately T-shaped in cross-section, with a head of dome-shaped construction, and is supported, by means of said dome-shaped head, on an occluding element 60 which is fixed, preferably by means of a screw connection, in the clearance 36 in the valve housing 35. The first occluding element 60 is sealed in relation to the valve housing 35 in known manner, for example by an O-ring or a copper seal. Canting-over of the peg 59 in the blind bore 58 of the valve 40 is prevented by the dome-shaped outer contour. This ensures that the higher frictional forces occurring in the event of canting-over do not occur and the functioning of the valve is not impaired.

The functioning of the scavenging valve 21 according to the invention will be explained in greater detail below with reference to FIG. 3. The diameter of the valve piston 40 in the region of the guide sections 56 and 57 corresponds with the diameter of the first clearance 48 in the first bush 44, or of the corresponding clearance on sides of the second bush 45. When the valve piston 40 is acted upon, in the second pressure space 43, by means of a hydraulic force which is greater than the hydraulic force in the first pressure space 41, said valve piston 40 is deflected towards the left in FIG. 3 against the force of the first centring spring 23.

On the first guide section 56 of the valve piston 40, there is produced, at the transition to that first end 46 of said valve piston 40 which is smaller in radial extent, a contact face 62 which, as a result of the movement of the valve piston 40 in the axial direction, passes into contact with the bottom of the first clearance 48 in the first bush 44. If the resulting axial force on the valve piston 40, which force is generated as a result of the pressure difference in the first pressure space 41 and the third pressure space 43, exceeds the oppositely directed force of the first centring spring 23, said first centring spring 23 is compressed in a manner corresponding to the axial movement of the valve piston 40. In the process, the first bush 44 lifts off the valve-seat face 50 and unblocks a connection, through which flow can take place, from the first pressure space 41, and thereby the first extracting line 25, to the second pressure space 42.

Said second pressure space is connected, in a manner which is not represented, to a tank volume 10. The maximum possible deflecting movement of the valve piston 40 is brought about by the length selected for the first end 46, or the distance, which results therefrom, from the head of the first abutment 52. As soon as the face of the valve piston 40 at the first end 46 is in contact with the abutment 52, further deflection is not possible.

The pegs 59 may serve as hydraulic damping pistons which cause the valve piston 40 to pass into its deflected end position in a damped manner, and thus avoid wear resulting from percussive stressing of the stops, for example when the end 46 bears against the abutment 52.

In the exemplified embodiment represented, the pressure in the second working line 5 exceeds the pressure in the first working line 4. If the pressure in the second working line 5 decreases, the resulting hydraulic force on the valve piston 40 also declines. If the difference between the hydraulic forces falls below a value which is predetermined by the force of the first centring spring 23, the valve piston 40 is displaced back in the direction of its central position by the force of said first centring spring 23 on the first bush 44. Under these circumstances, displacement as a result of the force of the first centring spring 23 is possible until the sealing face 49 of the first bush 44 is in contact with the valve-seat face 50 in the valve housing 35 and the first pressure space 40 is sealed in relation to the second pressure space 42.

In the exemplified embodiment represented, the distance between the two contact faces 62 and 63 constructed on the guide sections 56 and 57 is selected in such a way that the axial play of the valve piston 40, with the first bush 44 and second bush 45 bearing against the valve-seat face 50 of the valve housing 35 in each case, becomes virtually non-existent.

The arrangement in the second pressure space 43 consisting of the second end 47 of the valve piston 40, the second bush 45, the second centring spring 24 and also the second abutment 63 and the second occluding element 61, corresponds to that on the opposite side of the scavenging valve 21 which has been shown and described in detail. In the event of a pressure difference which is oppositely directed, compared to the example described, a deflection of the valve piston 40 in the opposite direction consequently takes place. In order to avoid repetition, a further detailed description will be dispensed with.

The invention is not restricted to the exemplified embodiment represented. In particular, for example, it is possible to provide, instead of a common second pressure space 42, two pressure spaces which are independent of one another and which are sealed, in each case, against the first pressure space 41 and the third pressure space 43 respectively.

The particular advantage of the arrangement selected, with bushes 44 and 45 which are pushed over the ends 46 and 47 of the valve piston 40, consists in the reduction in leakage oil losses as a result of the construction of a sealing face 49 on the bush, which sealing face cooperates in a sealing manner in conjunction with a valve-seat face 50 in the valve housing 35. Although it is not thereby possible to completely avoid the construction of the gap seal, said gap seal is nevertheless constructed between the central clearance in the bush 44, 45 and a sealing section on the valve piston 40, at the ends 46 and 47 of the latter, which cooperates with said clearance. The gap seal, which is inevitably subject to wear, can thus be produced by means of hardened components without expensive treatment of the valve housing 35. In addition, as has already been explained, the diameter of the gap seal is reduced, compared with a conventional mode of construction of the scavenging valve 21. Moreover, simple replacement of the components concerned is possible, so that reworking of the scavenging valve 21 in the event of wear is possible without, for example, having to bush the valve housing 35.

1. Scavenging valve for a hydraulic circuit, which valve has a valve piston which is arranged in a longitudinally displaceable manner in a clearance in a valve housing, wherein said scavenging valve has at least three pressure spaces which are constructed in an axially consecutive manner, and wherein two of said pressure spaces can be connected to one another at a time in dependence upon a relative position of the valve piston in relation to the valve housing,
wherein
in order to interrupt the connection between the pressure spaces, a sealing element, which effects sealing against a valve-seat face constructed in the housing, is provided in each case.

2. Scavenging valve according to claim 1,
wherein
the sealing element is constructed as a bush which is penetrated by the valve piston and cooperates in a sealing manner with a sealing section on said valve piston.

3. Scavenging valve according to claim 2,
wherein
a clearance for producing a sealing face is constructed on an end face of the bush which is oriented in the direction of the valve-seat face.

4. Scavenging valve according to claim 2,
wherein
the radial extent of the sealing sections on the valve piston is smaller than the radial extent between the sections of constructed guide sections.

5. Scavenging valve according to claim 1,
wherein
the scavenging valve has three pressure spaces and, when the valve piston is in a centred position, the second pressure space of a central section is sealed in relation to the pressure spaces of the other two sections by a sealing element in each case.

6. Scavenging valve according to claim 5,
wherein
for the purpose of centring the valve piston, said valve piston can be acted upon by means of an axial force via centring springs which are supported on the sealing elements.

7. Scavenging valve according to claim 6,
wherein
there are constructed on the valve piston contact faces which are oriented in the direction of the first bush and in the direction of the second bush respectively, and which transmit a movement of the valve piston for the purpose of lifting the respective bush off its valve-seat face.
